(19) United States
(12) Patent Application Publication
(10) Pub. No.: US 2021/0365913 A1
(43) Pub. Date: Nov. 25, 2021

(54) SYSTEMS AND METHODS FOR PROVIDING IDENTITY DATA TO A POINT OF SALE TERMINAL

(71) Applicant: The Toronto-Dominion Bank, Toronto (CA)

(72) Inventors: Milos DUNJIC, Oakville (CA); David Samuel TAX, Toronto (CA)

(73) Assignee: The Toronto-Dominion Bank, Toronto (CA)

(21) Appl. No.: 16/878,960

(22) Filed: May 20, 2020

(51) Int. Cl. G06Q 20/20; G06Q 20/40; G06Q 20/10; G06Q 20/38

(52) U.S. Cl. CPC G06Q 20/20; G06Q 20/382; G06Q 20/10; G06Q 20/4012

(57) ABSTRACT

A system comprises a communications module; a processor coupled with the communications module; and a memory coupled to the processor and storing processor-executable instructions which, when executed by the processor, configure the processor to receive, via the communications module and from a point of sale terminal, a PIN associated with a token and a request for identity data; authenticate the PIN to confirm customer consent to release the identity data; obtain the identity data; and send, via the communications module, the identity data to the point of sale terminal.

### TECHNICAL FIELD

The present disclosure relates to identity data and, in particular, to systems and methods for providing identity data to a point of sale terminal.

### BACKGROUND

Identity verification such as age verification has many uses. Often, identity verification is performed using low-tech solutions. For example, age verification for the purpose of buying certain age-restricted items (e.g. cigarettes, cannabis, alcohol) is often performed based on a government-issued identification document such as a driver's license or passport. Such verification methods can be prone to fraud since it is often possible to obtain fraudulent identity documents or to borrow identity documents from a person who may be related or may look like the purchaser.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a point of sale terminal;

FIG. 3 is a high-level schematic diagram of an example computer device;

FIG. 4 shows a simplified organization of software components stored in a memory of the example computer device of FIG. 3;

FIG. 5 is a flowchart showing operations performed by a server in providing identity data to a point of sale terminal according to an embodiment;

FIG. 6 is a flowchart showing operations performed by a server in obtaining identity data;

FIG. 7 is a flowchart showing operations performed by a server in obtaining identity data from a digital identity network;

FIG. 8 a flowchart showing operations performed by a server in providing identity data to a point of sale terminal according to another embodiment;

FIG. 9 is a flowchart showing operations performed by a server in providing identity data to a point of sale terminal according to another embodiment;

FIG. 10 is a flowchart showing operations performed by a server in providing identity data to a point of sale terminal according to another embodiment; and

FIG. 11 is an exemplary display screen of a mobile device.

Like reference numerals are used in the drawings to denote like elements and features.

### DETAILED DESCRIPTION OF VARIOUS EMBODIMENTS

According to an aspect there is provided, a system comprising a communications module; a processor coupled with the communications module; and a memory coupled to the processor and storing processor-executable instructions which, when executed by the processor, configure the processor to receive, via the communications module and from a point of sale terminal, a PIN associated with a token and a request for identity data; authenticate the PIN to confirm customer consent to release the identity data; obtain the identity data; and send, via the communications module, the identity data to the point of sale terminal.

In one or more embodiments, the request for identity data includes a request for a binary response indicating whether the customer has a particular attribute.

In one or more embodiments, the particular attribute includes a minimum age.

In one or more embodiments, the point of sale terminal is associated with a first financial institution and the token is associated with a second financial institution.

In one or more embodiments, the processor-executable instructions, when executed by the processor, further configure the processor to when it is determined that the first financial institution and the second financial institution are the same financial institution, obtain the identity data from a data store associated with the financial institution.

In one or more embodiments, the processor-executable instructions, when executed by the processor, further configure the processor to when it is determined that the first financial institution and the second financial institution are different financial institutions generate a digital identity request including a request for the identity data, the digital identity request having a format associated with a digital identity network storing data associated with a plurality of users; send, via the communications module and to the digital identity network, the digital identity request; and obtain, via the communications module, the identity data from the digital identity network.

In one or more embodiments, the digital identity network includes a permissioned blockchain network.

In one or more embodiments, the format associated with the digital identity network is a non-public format.

In one or more embodiments, the processor-executable instructions which, when executed by the processor, further configure the processor to receive, via the communications module and from the point of sale terminal, a transaction request indicating a transaction amount, the transaction request received together with the request for identity data.

In one or more embodiments, the transaction request includes one of a pre-authorized amount, a null amount, and an actual sale amount.

In one or more embodiments, the request for identity data includes at least one of a request for an age, a request for physical attributes and a request for credit information.

According to another aspect, there is provided a method comprising receiving, via a communications module and from a point of sale terminal, a PIN associated with a token and a request for identity data; authenticating the PIN to confirm customer consent to release the identity data; obtaining the identity data; and sending, via the communications module, the identity data to the point of sale terminal.

In one or more embodiments, the request for identity data includes a request for a binary response indicating whether the customer has a particular attribute.

In one or more embodiments, the particular attribute includes a minimum age.

In one or more embodiments, the point of sale terminal is associated with a first financial institution and the token is associated with a second financial institution.

In one or more embodiments, the method further comprises when it is determined that the first financial institution and the second financial institution are the same financial institution, obtaining the identity data from a data store associated with the financial institution.

In one or more embodiments, the method further comprises when it is determined that the first financial institution and the second financial institution are different financial institutions generating a digital identity request including a request for the identity data, the digital identity request having a format associated with a digital identity network storing data associated with a plurality of users; sending, via the communications module, the digital identity request to the digital identity network; and obtaining, via the communications module, the identity data from the digital identity network.

In one or more embodiments, the digital identity network includes a permissioned blockchain network.

In one or more embodiments, the method further comprises receiving, via the communications module and from the point of sale terminal, a transaction request indicating a transaction amount, the transaction request received together with the request for identity data.

According to another aspect there is provided a non-transitory computer readable storage medium comprising computer-executable instructions which, when executed, configure a processor to receive, via a communications module and from a point of sale terminal, a PIN associated with a token and a request for identity data; authenticate the PIN to confirm customer consent to release the identity data; obtain the identity data; and send, via the communications module, the identity data to the point of sale terminal.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

Payments or transactions are often made using point of sale terminals. For example, when a user or customer wishes to purchase an item, a token such as for example a credit card or debit card associated with an account of the customer is presented. The account of the customer is often associated with a financial institution that may be referred to as a provider financial institution. A point of sale terminal is used to receive the token. The point of sale terminal is configured to read data from the token, authenticate the user, and process the transaction. The transaction moves a transaction amount from the account of the customer to an account of the merchant. The account of the merchant is often associated with a financial institution. The financial institution associated with the merchant may be referred to as an acquirer financial institution. The point of sale terminal may be associated with the acquirer financial institution.

Systems and methods for providing identity data to a point of sale terminal are described below. As will be described, a token associated with a user is received by the point of sale terminal. The point of sale terminal prompts the user to enter a PIN associated with the token to confirm consent to release their identity data. The identity data may be obtained from a permissioned blockchain network used to provide a digital identity network. The permissioned blockchain network may only allow blocks to be written to a blockchain by nodes that are granted permission to write to the blockchain. At least some such blocks may be related to identity data. For example, at least some blocks may store a private secret, such as a hash of certain identity data. The identity data may be stored off-chain but the blockchain may be used to effectively provide proof of the data.

The systems and methods for providing identity data to a point of sale terminal require two step verification wherein the user must provide the token, such as for example a credit card or a debit card, and must enter a PIN associated with the token. Since most people are uncomfortable sharing both their token and the PIN associated with the token, the risk of identity fraud is reduced.

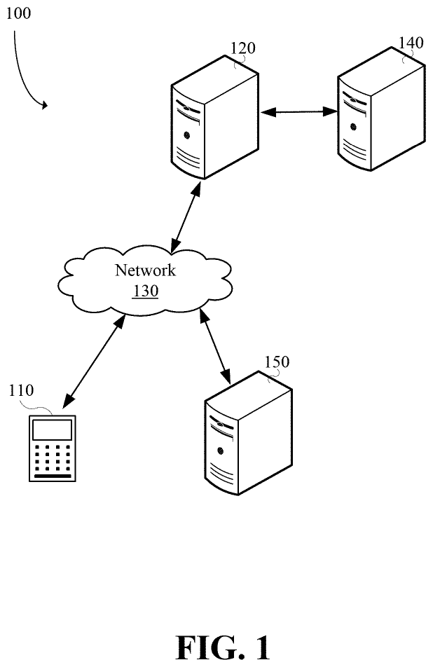

FIG. 1 is a schematic operation diagram illustrating an operating environment of an example embodiment. FIG. 1 illustrates a system 100 for obtaining identity data at a point of sale terminal.

As shown, a point of sale (POS) terminal 110 and a server 120 communicate via a network 130. The POS terminal 110 may associated with an entity, such as a merchant or acquirer, having resources associated with the server 120. The POS terminal 110 is configured to receive a token associated with a user and to display a prompt to the user to provide a PIN associated with the token. The POS terminal 110 may include a token interface that allows the POS terminal 110 to communicate with the token.

The token may have a contact form factor and/or a contactless (e.g. ISO 14443 based) form factor and may be implemented as a smart card, chip card, integrated circuit card, etc. The token is associated with a particular financial institution which may be referred to as a provider financial institution. The token may be, for example, a debit card or a credit card.

The POS terminal 110 is configured to generate or initiate a request for identity data of the user associated with the token. The request for identity data may be a request to verify particular identity data of the user associated with the token. For example, the identity request may be a request to verify that the user is of a particular age.

The POS terminal 110 may also be configured to generate or initiate a transaction request and send the transaction request to the server 120. The transaction request may be a request to process a transaction, such as a request to process an exchange of a transaction value for a transaction. The transaction request may be a request to modify a value in a database. The value may, for example, represent an account balance.

The POS terminal 110 may be configured to issue the request for identity data and the transaction request simultaneously.

The server 120 may be configured to process financial transactions based on transaction requests received from the POS terminal 110. The server 120 may be associated with a financial institution and may maintain merchant bank accounts. The financial institution may be referred to as a merchant or acquirer financial institution. The server 120 may also maintain customer bank accounts. That is, the server 120 may maintain a database that includes various data records. A data record may, for example, reflect an amount of value stored in a particular account associated with a user and/or a merchant. The server 120 may protect the data using bank-grade security.

While FIG. 1 illustrates a single server 120, more than one such server may be engaged and connected through the network 130. Further, the single server 120 may be connected to a data resource such as for example a computer system that includes one or more database servers, computer servers, and the like.

The server 120 may be configured to perform one or more functions described herein. Such functions may, for example, include communicating with the POS terminal 110 to authenticate a PIN entered by the user, processing a transaction and/or providing identity data to the POS terminal 110.

The server 120 may include a data store 140 that stores identity data for clients or customers of the financial institution associated with the server 120.

The system 100 comprises a digital identity network 150 that stores identity data. The digital identity network 150 is illustrated with a single block but it may be a network consisting of numerous computer systems. For example, the digital identity network may be a blockchain network which includes a number of nodes. The blockchain network is a decentralized peer-to-peer network in which nodes may maintain respective copies of an append-only ledger.

The blockchain network may be a permissioned blockchain network in which only authorized nodes are permitted to add blocks to the blockchain. For example, only verified nodes may be granted permission to write to the blockchain. The verified nodes may be trusted nodes such as nodes associated with government organizations or other trusted entities such as banks. By way of example, the verified nodes may be associated with a driver's license bureau, a credit bureau, a government identity issuing office such as a passport office or birth registry office, or an office of another type. Given ones of these nodes may maintain identity records of various types. For example, a node associated with a passport office may maintain digital passport records, a node associated with a driver's license bureau may maintain digital licensing records, a node associated with a credit bureau may maintain digital credit records, and a node associated with a bank may maintain digital banking records. Various verified nodes may maintain contact information records which may, for example, specify an email address, postal address, telephone number, or other type of contact information.

Accordingly, at least some verified nodes may write to the blockchain. At least some of the blocks written to the blockchain may be related to identity data. The digital identity network 150 may store identity data associated with a plurality of users. In at least some embodiments, identity data representing personal information may not be included in the blockchain. Instead, the blocks may store a private secret that is related to such digital identity data. The private secret may act as proof to the existence of the identity data and may be used to verify the authenticity of the data. For example, in at least some embodiments, the private secret may be a hash of the digital identity data such that, when the digital identity data is received from another system (i.e., a system apart from the verified node maintaining the digital identity data), it may be verified from the hash stored in a block on the blockchain. For example, in retrieving identity data from the digital identity network 150, the server 120 may obtain the identity data from another system and may use the data on the blockchain to verify such data.

The blockchain network may, for example, be implemented using Hyperledger Fabric, for example. It will, however, be appreciated that the blockchain network may take other forms.

The server 120 may retrieve identity data from the data store 140 and/or the digital identity network 150 and may provide the identity data to the POS terminal 110.

The POS terminal 110, the server 120, the data store 140 and the digital identity network 150 may be in geographically disparate locations. Put differently, the POS terminal 110, the server 120, the data store 140 and the digital identity network 150 may be remote from one another.

The network 130 is a computer network. In some embodiments, the network 130 may be an internetwork and may be formed of one or more interconnected computer networks. For example, the network 130 may be or may include an Ethernet network, an asynchronous transfer mode (ATM) network, a wireless network, a telecommunications network or the like.

Operations associated with the server 120 will be described in greater detail below.

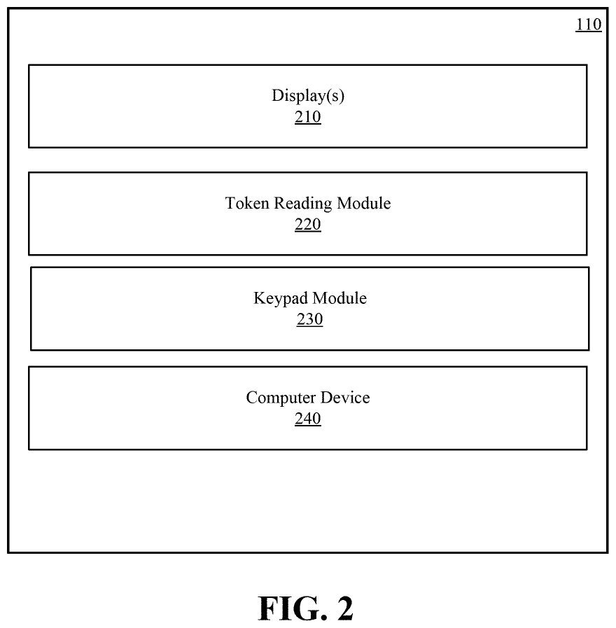

FIG. 2 is a simplified schematic diagram showing components of the POS terminal 110. The POS terminal 110 may include modules including, as illustrated, for example, one or more displays 210, a token interface 220, a keypad module 230 and a computing device 240.

The one or more displays 210 are a display module. The one or more displays 210 are used to display screens of a graphical user interface that may be used, for example, to display instructions to the user.

The token interface 220 may be used to receive and/or read a token such as for example a debit card or a credit card. For example, the token interface 220 may be configured to read data from a chip physically located on the token. The token interface 220 may utilize near field communications (NFC) to read data from the chip located on the token.

The keypad module 230 may be used to receive input from the user. For example, the keypad module 230 may be used by the user to enter a PIN and/or to provide answers to questions displayed by the display module 210. Further, the keypad module 230 may be used to enter a transaction amount.

The computer device 240 is in communication with the one or more displays 210, the token interface 220, and the keypad module 230. The computer device 240 may be or may include a processor which is coupled to the one or more displays 210, the token interface 220, and/or the keypad module 230.

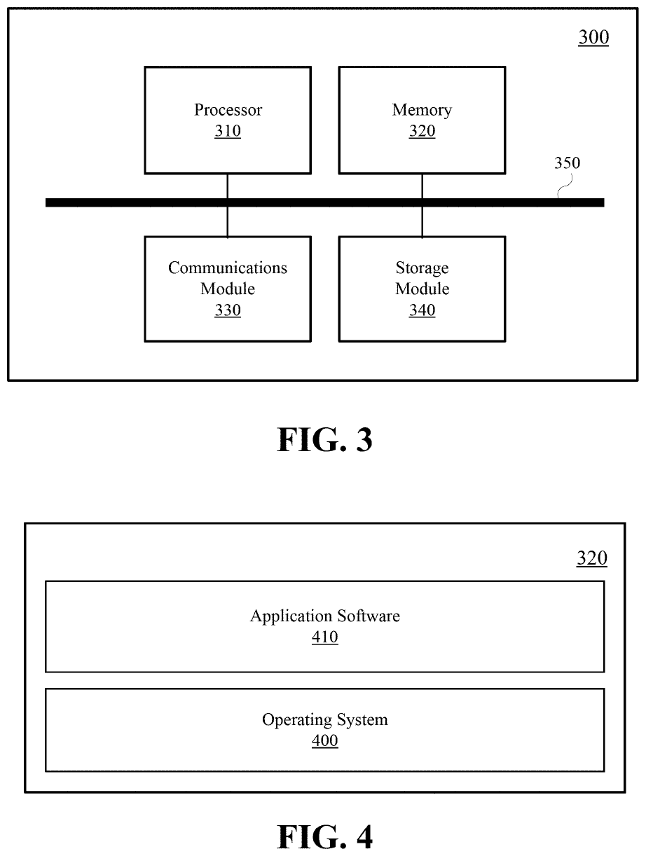

Referring now to FIG. 3, a high-level operation diagram of an example computer device 300 is shown. In some embodiments, the computer device 300 may be exemplary of the computer device 240 (FIG. 2), the server 120 and/or the digital identity network 150 (or a portion thereof, such as a node of the digital identity network 150).

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computing device 240 (FIG. 2) of the POS terminal 110 (FIG. 1), the server 120 (FIG. 1), and/or the digital identity network 150 (or a portion thereof, such as a node of the digital identity network 150).

While a single application 410 is illustrated in FIG. 3, in operation the memory 320 may include more than one application 410 and different applications 410 may perform different operations. For example, in at least some embodiments in which the computer device 300 is functioning as the POS terminal 110, the applications may include an application for causing the display module to display one or more prompts to the user. For example, the application may prompt the user to provide consent to access identity data by causing the display module to display “Please confirm that we have permission to conduct age verification.” The user may provide consent by pressing one or more buttons on the keypad of the POS terminal 110. When the user provides consent to access their identity data, the application may prompt the user to enter a PIN associated with the token by causing the display module display “Please enter your PIN.” As another example, the application may prompt the user to enter a PIN associated with the token. The PIN may be used to provide consent to allow the server 120 to conduct a transaction and/or access identity data of the user. The application may prompt the user by causing the display module to display “Please enter your PIN to confirm that you consent to age verification through your bank.”

In at least some embodiments in which the computer device 300 is functioning as the POS terminal 110, the applications may include an application for communicating a request for identity data to the server 120. The identity request may include a request for a binary response indicating whether the customer has a particular attribute. The particular attribute may be for example a minimum age. The identity request may include a request for an age, a request for physical attributes and/or a request for credit information. The application may allow the request to be customized by the merchant. For example, the application may allow the merchant to set the minimum age based on for example local laws. The application may receive a response to the request from the server 120. For example, when the identity request includes a request for a binary response indicating whether the customer has a particular attribute, the application may receive the binary response and may process the binary response as a YES or a NO response.

In at least some embodiments, the server 120 may be configured, through computer-executable instructions, to obtain identity data and process transactions. Embodiments of operations performed by the server 120 will now be described.

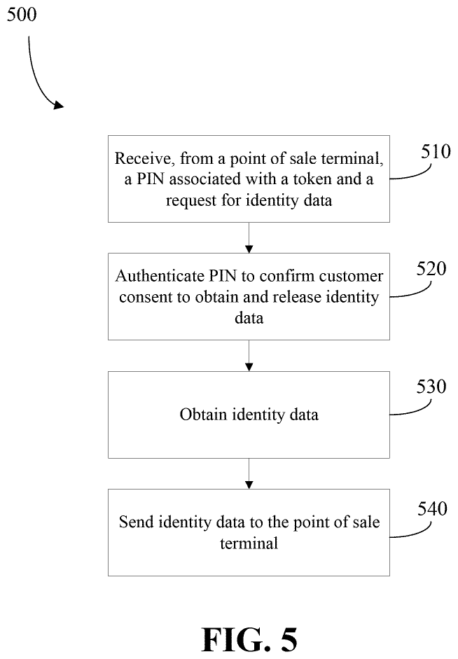

FIG. 5 is a flowchart showing operations performed by the server 120 according to an embodiment. The operations may be included in a method 500 which may be performed by the server 120. For example, computer-executable instructions stored in memory of the server 120 may, when executed by the processor of the server 120, configure the server 120 to perform the method 500 or a portion thereof.

The method 500 begins when the server 120 receives, via the communications module and from the POS terminal 110, a PIN associated with a token and a request for identity data (step 510). In this embodiment, the PIN is entered by the customer using the keypad of the POS terminal 110. The PIN may be a four (4) or six (6) digit number.

The request for identity data may include a request for a binary response indicating whether the customer has a particular attribute. For example, the request for identity data may be whether or not the user associated with the token has a minimum age. The minimum age may be set by the merchant and may be based on a minimum age required to purchase certain age-restricted items such as for example cigarettes, cannabis, alcohol, etc. As another example, the minimum age may be based on a minimum age requires to receive a senior's discount. The binary response may be a YES or a NO response. As will be appreciated, the binary response minimizes intrusion on the user's privacy.

The request for identity data may additionally or alternatively include at least one of a request for an age of the user, a request for physical attributes of the user, and a request for credit information of the user.

The PIN is authenticated to confirm customer consent to obtain and release identity data (step 520). In this embodiment, the server 120 compares the PIN entered by the user to the PIN associated with the token. When the PIN entered by the user matches the PIN associated with the token, the PIN is authenticated and as such customer consent to obtain and release identity data is confirmed.

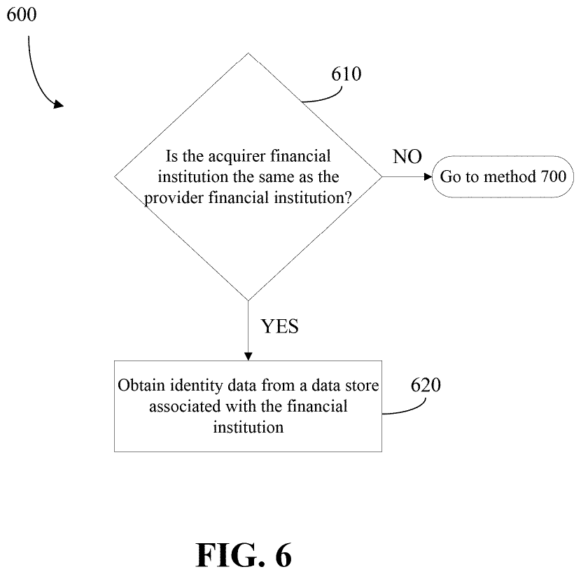

The server 120 obtains identity data (step 530). In this embodiment, the identity data is obtained according to a method 600 shown in FIG. 6 which may be performed by the server 120. For example, computer-executable instructions stored in memory of the server 120 may, when executed by the processor of the server 120, configure the server 120 to perform the method 600 or a portion thereof.

During method 600, a check is performed to determine if the merchant or acquirer financial institution is the same as the financial institution associated with the token or the provider financial institution (step 610). When it is determined that the acquirer financial institution is the same as the provider financial institution, the identity data is available to the financial institution through the data store 140. As such, the identity data is obtained from the data store 140 (step 620) and method 500 continues to step 540.

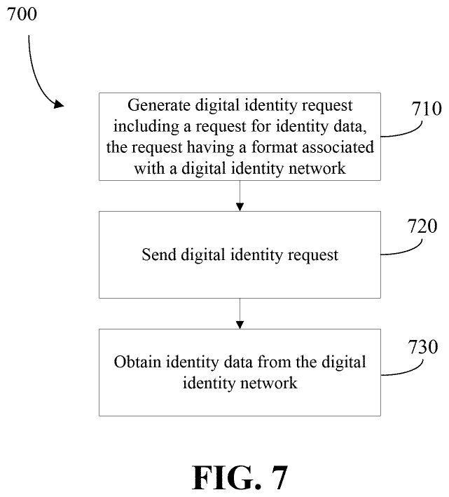

When it is determined that the acquirer financial institution is different than the provider financial institution, the identity data is not available from the data store 140 and as such the acquirer financial institution must obtain the identity data from a trusted provider. As one example, the trusted provider may include the provider financial institution and as such the requested identity data may be obtained therefrom. In another example, the trusted provider may include the digital identity network 150 and the identity data may be obtained from the digital identity network 150 according to a method 700 shown in FIG. 7 which may be performed by the server 120. For example, computer-executable instructions stored in memory of the server 120 may, when executed by the processor of the server 120, configure the server 120 to perform the method 700 or a portion thereof.

During method 700, the server 120 generates a digital identity request that includes a request for identity data (step 710). The digital identity request is generated in a format associated with digital identity network 150. The format may be a non-public format.

The digital identity request is sent to the digital identity network 150 (step 720). As mentioned, the digital identity network 150 may be a permissioned blockchain network and at least some of the blocks written to the blockchain may be related to identity data. The digital identity network 150 receives the digital identity request and obtains the requested identity data.

The identity data is obtained from the digital identity network 150 (step 730). The requested identity data is sent from the digital identity network 150 to the server 120 and method 500 continues to step 540.

The identity data is sent, via the communications module, to the POS terminal 110 (step 540). As mentioned, the request for identity data may include a request for a binary response indicating whether the customer has a particular attribute. In this example, the identity data obtained by the server 120 is analyzed and a response is sent to the POS terminal 110 as a binary response indicating whether or not the customer has the particular attribute. For example, the request may be “Is the user over the age of twenty-one (21)?” and the identity data sent to the POS terminal 110 may be “YES” or “NO”. The binary response ensures that the user's actual age is not shared with the POS terminal 110. Rather, the binary response simply confirms whether or not the user meets the minimum age requires to purchase, for example, age-restricted items such as for example cigarettes, cannabis, alcohol, etc. As another example, the binary response may confirm whether or not the user meets the minimum age requires to receive a discount such as for example a senior's discount. The binary response minimizes intrusion on the user's privacy as the binary response indicates whether or not the user meets age requirements without sharing any additional identity data of the user.

As mentioned, the request for identity data may include at least one of a request for an age of the user, a request for physical attributes of the user, and a request for credit information of the user. The identity data sent to the POS terminal 110 is only the requested identity data. For example, the request for identity data may be a request for an age of the user and as such only the age of the user may be sent to the POS terminal 110. Physical attributes of the user may be sent to the POS terminal 110 for review by the merchant to confirm the identity of the user. For example, height, weight, hair colour and eye colour may be sent to the POS terminal 110. The merchant can review the physical attributes of the user to confirm the identity of the user. Credit information may be provided to the POS terminal 110. In this example, the merchant may be selling a luxury item such as for example a car or jewelry and the credit information may be obtained by the POS terminal 110 to ensure the user has sufficient credit to purchase the luxury item. By only providing the identity data requested by the POS terminal 110, intrusion of the user's privacy is minimized.

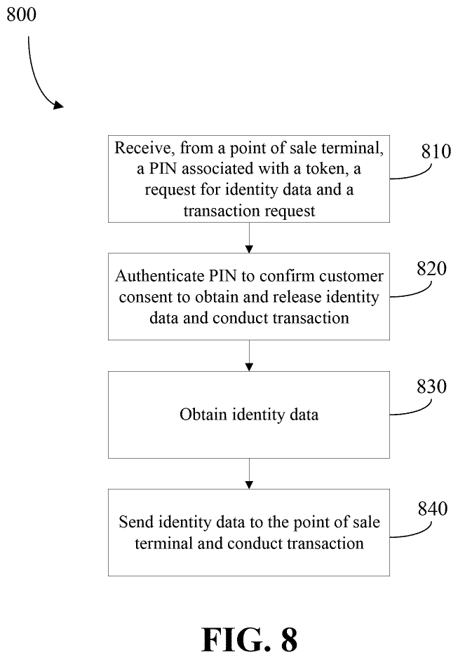

In another embodiment, the request for identity data may be provided at the same time as a transaction request. In this embodiment, only a single request is required to obtain identity data and conduct a transaction. FIG. 8 is a flowchart showing operations performed by the server 120 according to an embodiment. The operations may be included in a method 800 which may be performed by the server 120. For example, computer-executable instructions stored in memory of the server 120 may, when executed by the processor of the server 120, configure the server 120 to perform the method 800 or a portion thereof.

The method 800 begins when the server 120 receives, via the communications module and from the POS terminal 110, a PIN associated with a token, a request for identity data and a transaction request (step 810). In this embodiment, the PIN associated with the token and the request for identity data are received in a similar manner to that of step 510 of method 500. In this embodiment, the request for identity data includes a request for a binary response indicating whether the customer has a particular attribute. The transaction request may specify a transaction amount for purchasing age-restricted items such as for example cigarettes, cannabis, alcohol, etc.

In an example, the transaction amount may be a pre-authorization amount. In this example, the request for identity data includes a request for a binary response indicating whether the customer has a particular attribute such as having a minimum age to enter a bar or a restaurant. The pre-authorization amount may be used to ensure the user does not leave the bar or restaurant without paying their bill.

In another example, the transaction amount may be a null amount or a zero dollar amount. In this example, the request for identity data includes a request for a binary response indicating whether the customer has a particular attribute such as having a minimum age to enter a bar or a restaurant. The null amount may be used to process the request for identity data without requiring a separate or specially programmed POS terminal 110. Put another way, the null amount may be used to ensure that the POS terminal 110 processing the request for identity data may also be used to process transactions for the merchant.

The PIN is authenticated to confirm customer consent to obtain and release identity data and confirm consent to conduct the transaction (step 820). The PIN is authenticated in a similar manner to that of step 520 of method 500.

The server 120 obtains identity data (step 830). The identity data is obtained in a manner similar to that of step 530 of method 500.

The identity data is sent, via the communications module, to the POS terminal 110 and the transaction is conducted (step 840). In this embodiment, the identity data is sent to the POS terminal 110 in a manner similar to that of step 540 of method 500. The transaction is conducted such that the transaction amount is debited from the account of the user and credited to the account of the merchant.

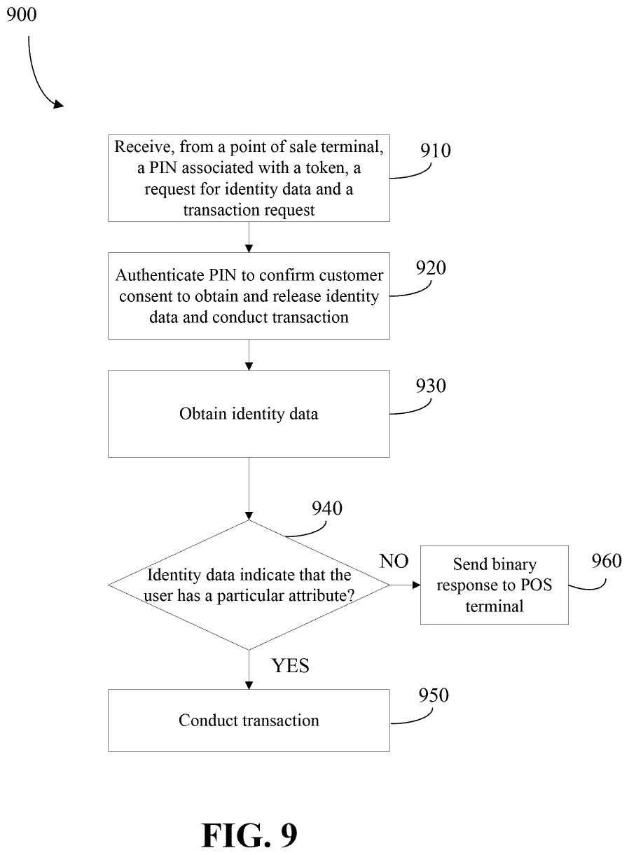

In another embodiment, the identity data may be used to selectively conduct a transaction. FIG. 9 is a flowchart showing operations performed by the server 120 according to an embodiment. The operations may be included in a method 900 which may be performed by the server 120. For example, computer-executable instructions stored in memory of the server 120 may, when executed by the processor of the server 120, configure the server 120 to perform the method 900 or a portion thereof.

Steps 910, 920 and 930 are generally similar to that of steps 810, 820 and 830, respectively, with those of method 800. In this embodiment, during step 910, the request for identity data includes a request for a binary response indicating whether the customer has a particular attribute.

A check is performed to determine if the binary response indicates whether the customer has a particular attribute such as for example a minimum age to purchase age-restricted items (step 940). When the customer has the particular attribute, the transaction is conducted (step 950). The transaction may be conducted in a similar manner to that described above.

During step 940, when the customer does not have the particular attribute, the binary response is sent to the POS terminal 110 indicating to the merchant that the user does not have the particular attribute (step 960). For example, the binary response may indicate that the user is under the age of twenty-one (21) and thus not legally allowed to purchase an age-restricted item.

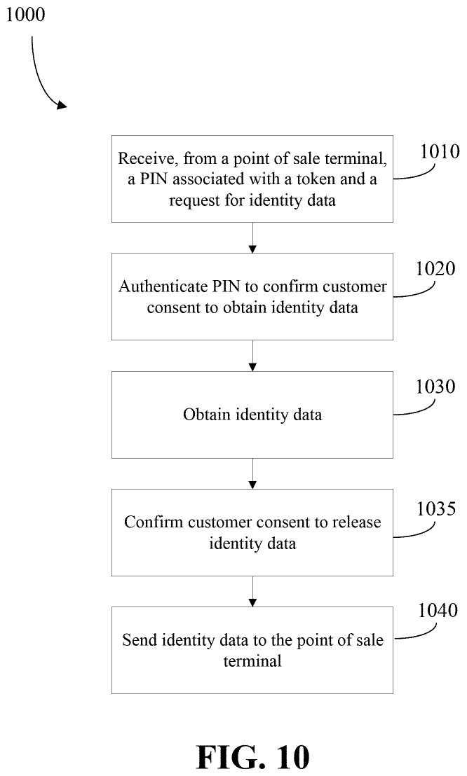

Although in embodiments, a PIN associated with a token is authenticated and used to indicate customer consent to obtain and release identity data, consent to release the identity data may be indicated in additional or alternative manners. FIG. 10 is a flowchart showing operations performed by the server 120 according to another embodiment. The operations may be included in a method 1000 which may be performed by the server 120. For example, computer-executable instructions stored in memory of the server 120 may, when executed by the processor of the server 120, configure the server 120 to perform the method 1000 or a portion thereof.

Step 1010 is generally similar to that of step 510 of method 500 in that the server 120 receives, via the communications module and from the POS terminal 110, a PIN associated with a token and a request for identity data (step 1010).

The PIN is authenticated to confirm customer consent to obtain identity data (step 1020). In this embodiment, the server 120 compares the PIN entered by the user to the PIN associated with the token. When the PIN entered by the user matches the PIN associated with the token, the PIN is authenticated and as such customer consent to obtain identity data is confirmed.

Step 1030 is generally similar to that of step 530 of method 500 in that the server 120 obtains identity data (step 1030). In this embodiment, the identity data may include data associated with a mobile device of the user such as for example a telephone number, email address, etc.

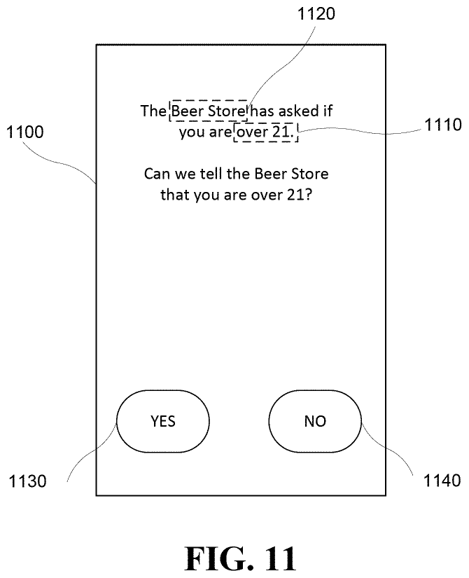

Once the identity data is obtained, user consent to release the identity data to the POS terminal 110 is obtained (step 1035). In this embodiment, consent to release the identity data is obtained by sending a message to the mobile device of the user. The message may be sent through a mobile application stored on the mobile device or may be sent as a text message to the mobile device. The message may cause the mobile device to generate a prompt to request consent input. The prompt may be provided on a display screen 1100 shown in FIG. 11. The display screen 1100 may display the identity data 1110 (excluding the data associated with the mobile device) that was requested from the POS terminal 110. In at least some embodiment, identifying information 1120 of the merchant associated with the POS terminal 110 may also be displayed. The display screen 1100 includes a selectable option 1130 to share the identity data with the merchant via the POS terminal 110 and selectable option 1140 to not share the identity data with the merchant via the POS terminal 110. When the selectable option 1140 is activated, this may indicate to the user of the client device that someone may be trying to use their identity.

When the selectable option 1130 is activated, the mobile device sends a message to the server 120 which includes an indication of consent to release the identity data to the POS terminal 110.

The identity data is sent to the POS terminal 110 (step 1040) in a manner similar to that of step 540 of method 500.

As will be appreciated, by requiring user consent to release the identity data to the POS terminal 110 via their mobile device, this further prevents or minimizes the risk of fraud as the request for consent requires that the user has their mobile device with them. As will be appreciated, in some embodiment the mobile device itself may require that the user enter a PIN or may require biometric data of the user to unlock the phone and provide a response to the request to release the identity data. For example, the user's finger print may be required to unlock the mobile device before the user can provide consent. If the mobile device of the user receives a request to share the identity data and the user is not aware of the request, then this may be an indication to the user that someone is attempting to use their identity.

In another embodiment, location data associated with a mobile device of the user may be used to identify a location of the user to ensure that the user is within proximity of the merchant. For example, if a user is attempting to purchase, for example, age-restricted items such as for example cigarettes, cannabis, alcohol, etc., location data of a mobile device associated with the user may be used to ensure that the user attempting the purchase is the same user of the requested identity data and that the user is located within proximity of the merchant associated with the POS terminal 110.

Although in embodiments described above, a token is described as being in the form of a credit card or a debit card, those skilled in the art will appreciate that in another embodiment the token may be associated with a mobile device of the user. For example, the token may be associated with a digital credit card stored within a mobile wallet on the mobile device of the user. Examples of such mobile wallets are Google Pay™, Apple Pay™, etc. In this example, the token may be read by the POS terminal 110 using, for example, near field communications (NFC). In response to reading data from the token, the POS terminal 110 may request the user to enter a PIN. Alternatively, the mobile wallet of the mobile device may require the user to unlock the mobile device using for example a PIN or biometric data and this may be used to indicate consent to the POS terminal 110 to release and obtain identity data.

The methods described above may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A system comprising:
a communications module;
a processor coupled with the communications module; and
a memory coupled to the processor and storing processor-executable instructions which, when executed by the processor, configure the processor to:
receive, via the communications module and from a point of sale terminal, a PIN associated with a token together with a transaction request and a request for identity data, the request for identity data including a request for a binary response indicating whether a customer has a particular attribute;
authenticate the PIN to confirm customer consent to release the identity data;
obtain the identity data and determine the binary response;
determine that the binary response indicates that the customer has the particular attribute;
responsive to determining that the binary response indicates that the customer has the particular attribute, complete a transaction based on the transaction request; and
send, via the communications module, a confirmation of the completed transaction to the point of sale terminal.

2. (canceled)

3. The system of claim 1, wherein the particular attribute includes a minimum age.

4. The system of claim 1, wherein the point of sale terminal is associated with a first financial institution and the token is associated with a second financial institution.

5. The system of claim 4, wherein the processor-executable instructions, when executed by the processor, further configure the processor to:
when it is determined that the first financial institution and the second financial institution are the same financial institution, obtain the identity data from a data store associated with the financial institution.

6. The system of claim 4, wherein the processor-executable instructions, when executed by the processor, further configure the processor to:
when it is determined that the first financial institution and the second financial institution are different financial institutions:
generate a digital identity request including a request for the identity data, the digital identity request having a format associated with a digital identity network storing data associated with a plurality of users;
send, via the communications module and to the digital identity network, the digital identity request; and
obtain, via the communications module, the identity data from the digital identity network.

7. The system of claim 6, wherein the digital identity network includes a permissioned blockchain network.

8. The system of claim 6, wherein the format associated with the digital identity network is a non-public format.

9. (canceled)

10. The system of claim 1, wherein the transaction request includes one of a pre-authorized amount, a null amount, and an actual sale amount.

11. The system of claim 1, wherein the particular attribute includes at least one of a request for an age, a request for physical attributes and a request for credit information.

12. A method comprising:
receiving, via a communications module and from a point of sale terminal, a PIN associated with a token together with a transaction request and a request for identity data, the request for identity data including a request for a binary response indicating whether a customer has a particular attribute;
authenticating the PIN to confirm customer consent to release the identity data;
obtaining the identity data and determining the binary response;
determining that the binary response indicates that the customer has the particular attribute;
responsive to determining that the binary response indicates that the customer has the particular attribute, completing a transaction based on the transaction request; and
sending, via the communications module, a confirmation of the completed transaction to the point of sale terminal.

13. (canceled)

14. The method of claim 12, wherein the particular attribute includes a minimum age.

15. The method of claim 12, wherein the point of sale terminal is associated with a first financial institution and the token is associated with a second financial institution.

16. The method of claim 15, further comprising:
when it is determined that the first financial institution and the second financial institution are the same financial institution, obtaining the identity data from a data store associated with the financial institution.

17. The method of claim 15, further comprising:
when it is determined that the first financial institution and the second financial institution are different financial institutions:
generating a digital identity request including a request for the identity data, the digital identity request having a format associated with a digital identity network storing data associated with a plurality of users;
sending, via the communications module, the digital identity request to the digital identity network; and
obtaining, via the communications module, the identity data from the digital identity network.

18. The method of claim 17, wherein the digital identity network includes a permissioned blockchain network.

19. (canceled)

20. A non-transitory computer readable storage medium comprising computer-executable instructions which, when executed, configure a processor to:
receive, via a communications module and from a point of sale terminal, a PIN associated with a token together with a transaction request and a request for identity data, the request for identity data including a request for a binary response indicating whether a customer has a particular attribute;
authenticate the PIN to confirm customer consent to release the identity data;
obtain the identity data and determine the binary response; and
determine that the binary response indicates that the customer has the particular attribute;
responsive to determining that the binary response indicates that the customer has the particular attribute, complete a transaction based on the transaction request; and
send, via the communications module, a confirmation of the completed transaction to the point of sale terminal.
